(19) United States
(12) Patent Application Publication
(10) Pub. No.: US 2025/0113190 A1
(43) Pub. Date: Apr. 3, 2025

(54) ARTIFICIAL INTELLIGENCE AND MACHINE LEARNING TECHNOLOGIES FOR WIRELESS COMMUNICATION

(71) Applicant: Apple Inc., Cupertino, CA (US)

(72) Inventors: Sudeep Manithara Vamanan, Nuremberg (DE); Arnab Roy, San Diego, CA (US); Oner Orhan, San Jose, CA (US); Walter Featherstone, Cirencester Gloucestershire (GB); Onur Sahin, Highland, CA (US); Krisztian Kiss, Rancho Santa Fe, CA (US); Ahmed M. Soliman, Munich Bavaria-Bayern (DE)

(73) Assignee: Apple Inc., Cupertino, CA (US)

(21) Appl. No.: 18/819,937

(22) Filed: Aug. 29, 2024

Related U.S. Application Data
(60) Provisional application No. 63/541,620, filed on Sep. 29, 2023.

(51) Int. Cl. H04W 12/08

(52) U.S. Cl. CPC H04W 12/08

(57) ABSTRACT

The present application relates to devices and components, including apparatus, systems, and methods for an application function (AF) direct access to a radio access network (RAN) management function.

### CROSS-REFERENCES TO OTHER APPLICATIONS

This application claims priority to U.S. Provisional Application No. 63/541,620, for “ARTIFICIAL INTELLIGENCE AND MACHINE LEARNING TECHNOLOGIES FOR WIRELESS COMMUNICATION,” filed on Sep. 29, 2023, which is herein incorporated by reference in its entirety for all purposes.

### TECHNICAL FIELD

This application relates generally to communication networks and, in particular, to technologies for influencing network functions by an application function.

### BACKGROUND

Artificial intelligence and machine learning (AIML) may be used in wireless communication to automate tasks, optimize network resources, or predict and mitigate problems. AIML models may be used to optimize radio resource management (RRM) parameters such as channel allocation, power control, or scheduling. AIML may be used for mobility management, interference management, or security threat detection.

For example, the AIML models and algorithms may be used in a 3GPP network in the context of network slicing. AIML may be used to automate the deployment and management of network slices.

### BRIEF DESCRIPTION OF THE DRAWINGS

FIG. 1 illustrates a network environment in accordance with some embodiments.

FIG. 2 illustrates an operational flow/algorithmic structure in accordance with some embodiments.

FIG. 3 illustrates a signaling diagram in accordance with some embodiments.

FIG. 4 illustrates a network environment in accordance with some embodiments.

FIG. 5 illustrates a signaling diagram in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

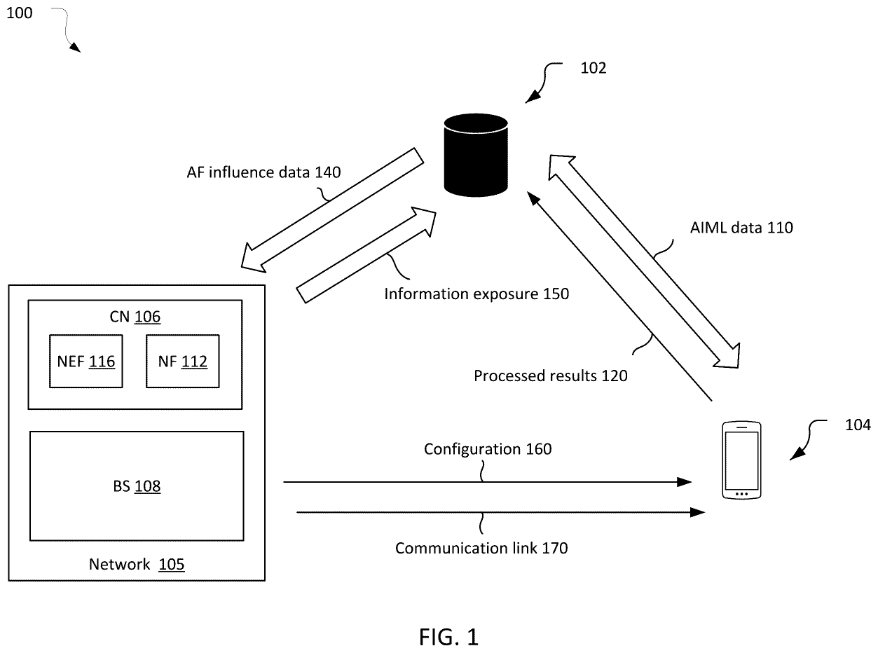

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The network environment 100 may include a network 105. The network 105 may provide services, e.g., voice or data connectivity, to the UE 104. Network 105 may include a core network (CN) 106 or the BS 108. The CN 106 may connect the BS 108 and the UE 104 to other entities, e.g., an edge data network (EDN), the Internet, or an application function (AF) 102. The CN 106 may be responsible for call and session configuration or control, mobility management, or service provisioning.

The CN 106 may include one or more network functions, e.g., a network exposure function (NEF) 116 or a network function NF 112. The NF 112 is a generic network function and may represent any network function provided by the CN 106. The NF 112 may manage or control the operation of a network node. For example, the NF 112 may be a RAN management function that controls the operation and configurations of the BS 108 or the UE 104.

The AF 102 may be a functional element that may provide information related to services or applications to other network functions. In some instances, the AF 102 is a function managed by the network operator. In some instances, the AF 102 may be a 3^{rd} party function residing in the cloud or 3^{rd} party servers.

The AF 102 may be coupled with the network 105 through the CN 106. The AF 102 may be coupled with the NEF 116. In some embodiments, the AF 102 may be coupled with the NF 112. In some instances, the AF 102 may communicate with the NF 112 through NEF 116, e.g., the AF 102 may send a message to the NEF 116, and the NEF 116 may forward the message to the NF 112. In some instances, the AF 102 may directly communicate with the NF 112, e.g., the AF 102 may send a message directly to the NF 112.

The UE 104 may be communicatively coupled with the BS 108 through communication link 170. The UE 104 may collect data related to the communication link 170 or other information related to the UE 104. The collected data may be associated with the end user's intent, context, or prospective actions. For example, in a vehicle-to-everything V2X system, the UE, e.g., the vehicle, may have information related to the user's intent to cross the lane, distraction level, or destination. The UE 104 may also receive information from network 105, other UEs, or other data networks. The UE 104 may use the data to predict configuration, e.g., traffic profile or operating modes. The UE 104 may use AIML models to analyze the information and obtain predictions or results.

The UE 104 may process the data and generate the AIML data 110. The UE may share the AIML data 110 with the AF 102. The UE 104 may share processed results 120 with the AF 102. The processed results 120 may include predictions, inferences, or AIML models developed by the UE 104 or applications or functions associated with the UE 104.

The AF 102 may interact with network 105 to obtain authorization to access entities and elements associated with network 105. The AF 102 may influence the operation of network 105 through its interaction with NEF 116 or NF 112. For example, the AF 102 may influence traffic routing for applications and interact with the policy control function (PCF) to enable policy control. The NEF 116 may provide means for the AF 102 to access network capabilities and resources. By exposing the capabilities, e.g., network functions or resources, the NEF 116 or the AF 102 may influence how the exposed NFs or resources operate or interact with each other. The AF 102 may influence data session configurations, traffic routing, or quality of service (QOS) parameters. The network 105 may send configuration 160 to the UE 104 based on the AF 102 influence.

In some embodiments, the AF 102 may influence mobility, session management policies, and configurations associated with the BS 108 or UE 104.

In some embodiments, the AF 102 may act on behalf of the UE 104 to influence the operation of network 105 based on the UE's information or inferences.

Network 105 may authorize the AF 102 to access NEF 116 or the NF 112. The network 105 may send information exposure 150 to the AF 102. The information exposure 150 may include data applicable or associated with the AIML model or analytics. The information exposure 150 may include a list of NFs or resources that the AF 102 is authorized to access or influence.

The AF 102 may provide AF influence data 140 to the network 105. The AF influence data 140 may include raw data, e.g., measurement data, analyzed data, e.g., AIML data or processed results, or AIML models or parameters.

Due to privacy concerns, it may be desired for the UE 104 or the AF 102 to keep the raw measurements or data in the device. An AIML running locally may generate results and inferences based on the data. Direct access to influence an NF 112 may enable the UE 104 or the AF 102 to perform real-time or near real-time procedures or supporting applications that may need a fast control loop.

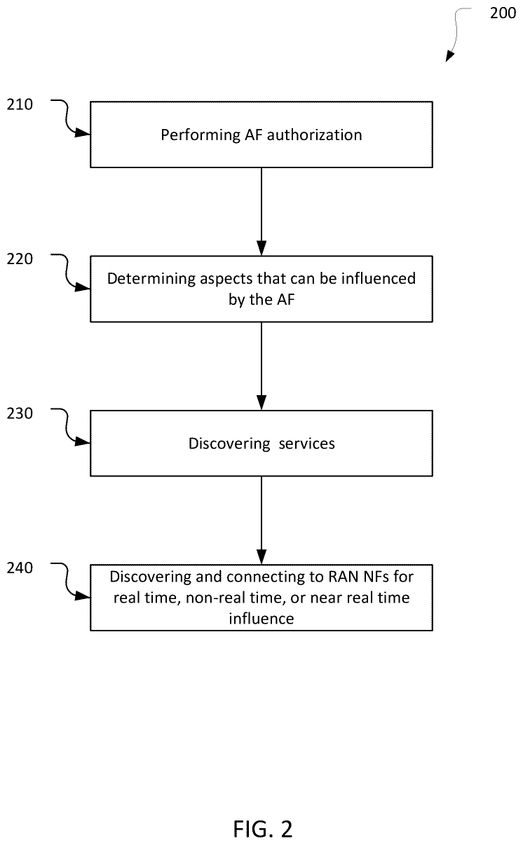

FIG. 2 illustrates an operational flow/algorithmic 200 structure in accordance with some embodiments. Operational flow/algorithmic structure 200 is an example of the operation of the AF 102 to influence the network 105. The operational flow/algorithmic structure 200 may be implemented by a network node, for example, the network node 1000, or components therein, e.g., processors 1004.

The operation flow/algorithmic structure 200 may include, at 210, performing an AF authorization. The AF may be an example of AF 102 in FIG. 1. The AF authorization may be performed by the mobile network operator (MNO) or by the UE, e.g., the UE 104 in FIG. 1.

The AF may be a component of a 3^{rd} party service that interacts with the core network, e.g., the CN 106 in FIG. 1, to influence the network operation. The authorization procedure of the AF may ensure that the AF has the necessary permissions to interact with the network.

The operation flow/algorithmic structure 200 may include, at 220, determining aspects that can be influenced by the AF. For example, the AF may request accessing an NF. The network may perform an authorization, including user consent management operation, to determine whether to permit the AF to access and to determine the scope of access.

The user consent management may involve obtaining explicit permission from the user before an AF can access or use certain information or services on UE's behalf. Consent management may be essential in handling sensitive information or operations that may impact user experience or privacy. For example, an AF may request to access a user's network slice. The network may need to ensure that the AF is authorized to access only specific network slices and prevent it from accessing information of other network slices. This authorization process may involve obtaining consent from the user.

The operation flow/algorithmic structure 200 may include, at 230, discovering available services and functions. For example, the AF may discover available services through the NEF. The available services may be associated with the services the AF has authorization to access or influence.

Service discovery may involve the AF querying the network to determine available services. This may include communication with various NFs such as network repository function (NRF) or NEF.

The operation flow/algorithmic structure 200 may include, at 240, discovering and connecting to an NF associated with the RAN, e.g., the RAN management function or RAN NF, for real-time, non-real-time, or near real-time influence.

The AF may send influence data, e.g., raw data, AIML models, or UE-originated data or models, to an NF. The NF may consider the AF inputs, e.g., the influence data, or data from other NFs, e.g., the network data analytics function (NWDAF).

The AF may influence the network operation through the parameter provisioning procedure. The AF may provide parameters to the network through parameter provisioning, e.g., to NEF or other NFs. The receiving NF may use the received parameter to determine configuration parameters or network operations. For example, the AF may provide certain physical layer (PHY) configurations to the RAN NF. The RAN NF may use the PHY configurations to configure the UE, e.g., via a radio resource control (RRC) configuration signaling.

The AIML provisioning may include obtaining the UE (or end-user) consent. The consent may be blanket consent provided to a specific AF, or it may be granular consent provided per action or aspects that are being influenced. The consent may be applied for a specific period or geographic location. The UE consent can be updated through network or application layer signaling, e.g., over-the-top (OTT) signaling.

The AIML-based provisioning may provide granular control of UE configuration. For example, access to RAN, the UE, through AF, or AF on behalf of the UE may influence RAN parameters. Direct access to RAN may enable a fast control loop for near real-time operations. The AF may access the RAN node directly or through a local NEF (e.g., local to the RAN node). For example, AF may access AIML RAN NFs such as RAN AI/ML model or data repository functions or RAN AIML model or data coordination function. The parameter provisioning may mask aspects related to the user's intent, sensitive or private information, e.g., identifiers, or system information, e.g., applications or device settings that are deemed private.

The receiving NF may correlate or combine the parameter provisioning inputs from the AF with the NWDAF. For example, AF inputs may be combined with analytics from NWDAF by the MNO. The network may provide relevant NWDAF analytics to AF. The AF may combine or correlate the NWDAF analytics and incorporate them in parameter provisioning, or the AF may provide the NWDAF analytics to the UE, and the UE may consider the NWDAF analytics into triggering parameter provisioning.

AF may use parameter provisioning to influence CN parameters. For example, AF may influence UE operating modes, long-term UE behavior, e.g., UE subscriptions for slices, or short-term behavior, e.g., session lifetime or QoS flow lifetime. The AF may influence CN mobility management policies, e.g., suggested registration area, periodicity of the mobility registration update (MRU) messages, or parameters associated with radio link failure. The AF may influence the CN to change semantic communication flow characteristics dynamically.

AF may use parameter provisioning to influence RAN configurations. For example, AF may influence duty cycle, preferred carrier aggregation configurations, measurement configurations for power saving, radio resource allocation, beamforming selection, RRM, RAN mobility configuration including beam groups, or transmission and receive point (TRP) selection. The AF may influence the AIML mode at the NF.

The AF may influence the network in device-to-device (D2D) communication. For example, the AF may influence parameters associated with D2D authorization, sidelink UE selection, route selection, or sidelink RRM.

The AF may influence open RAN (ORAN) functions across rApp, xApp, SMO, A1, E2, or O1. For example, AF may influence ORAN Xn-based multi-gNB coordination. The rApp, xApp, SMO, A1, E2, O1, or Xn interfaces are ORAN services or interfaces according to ORAN specifications.

The AF may influence network policies through parameter provisioning. For example, the AF may recommend AIML policy selection or influence NFs associated with UE known performance indicators (KPI), failures, or error rates.

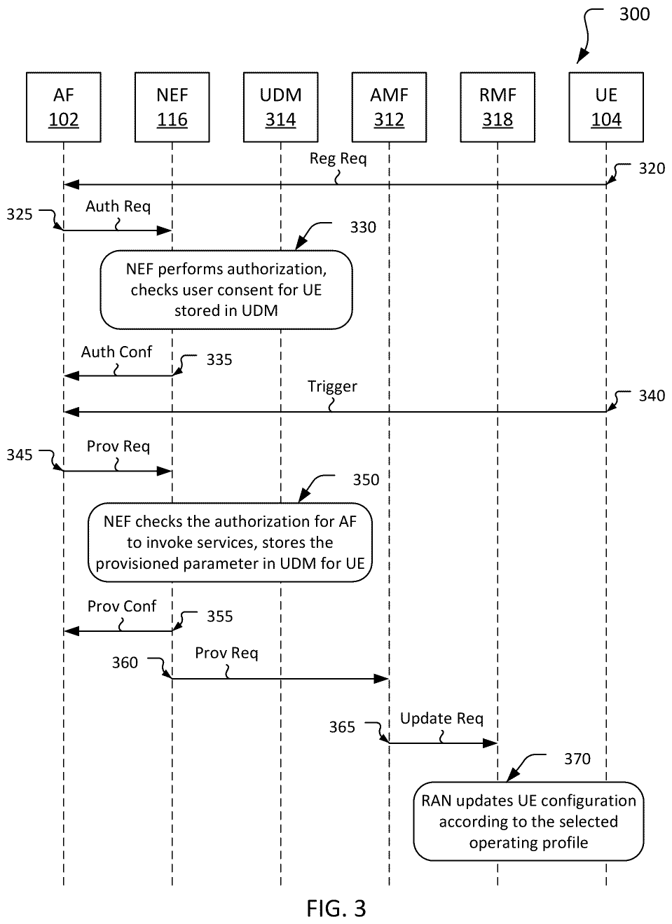

FIG. 3 illustrates a signaling diagram 300 in accordance with some embodiments. Signaling diagram 300 may be an example of a provisioning procedure for setting a UE operating profile. UE operating profile may include a set of UE configurations, e.g., radio access capabilities, network capabilities, or mobility preferences. For example, the UE or AF may influence network decisions related to mobility update timers, allowed network slices, or radio configurations. A UE may register one or more operating profiles with the network. Based on AIML inference, the AIML function at the UE or AF may determine and select an operating profile. For example, the AIML inference may be based on knowledge or information about AIML capability or available datasets. The UE or AF may invoke NEF APIs to provision the configuration corresponding to the UE operating profile.

At 320, the UE 104 may send a registration request to the AF 102. For example, the AIML client in the UE may register with the AF to trigger authorization or onboarding with the MNO NEF 116. The UE may use application layer signaling to send UE registration request. The registration request or another message may include a list of provisioning parameters and consent inputs, e.g., one or more indications to one or more consents.

At 325, the AF 102 may check whether an authorization exists. If no authorization is associated with the NEF 116, the AF 102 may send an authorization request message to the NEF 116. For example, the AF 102 may use a Nnef_AFAuthorization_Request message to request authorization from the NEF 116. The authorization request message may include a UE identifier (ID), a list of allowed UE provisioning parameters for which the AF 102 has received the user's consent.

At 330, NEF 116 may perform authorization in response to the authorization request message from AF 102. The NEF 116 may use the consent input and information associated with the consent retrieved from unified data management (UDM) 314 to authorize the AF 102. UDM may be a network node or NF that manages network users' data. For example, the NEF 116 may retrieve the UE consent information stored in the UDM.

At 335, the NEF 116 may send an authorization confirmation message to the AF 102. For example, the NEF 116 may use the Nnef_AFAuthorization_Confirm message to inform the AF 102 whether the AF 102 is authorized to access NEF 116 or other NFs. The authorization confirmation message may include an indication, e.g., authorization information, indicating that the AF 102 is authorized to access the NEF 116 or other NFs. The authorization confirmation message may include an authorization ID. When accessing the NEF 116 or other NFs, the AF 102 may use the authorization ID to indicate that it has authorization. The authorization confirmation may include a validity time that may indicate the duration for which the authorization is valid. The AF 102 may configure a timer based on the validity time.

At 340, based on AIML inference, the AIML client in the UE 104 may trigger the AF 102 for parameter provisioning. The UE 104 may use application layer signaling to send the trigger to the AF 102. The trigger may include an indication of the UE's operating mode. The trigger may be based on inference or partial inference results. The inference or the trigger may be combined with other inference results at the AF. The other inferences at the aF may be provided by the core network NFs, e.g., NWDAF, RAN-related NFs, or other CN NFs.

At 345, the AF 102 may invoke parameter provisioning service at an NF. The AF 102 may invoke parameter provisioning services at the NEF 116 by sending a provisioning request message to the NEF 116. For example, the AF 102 may send a Nnef_ParameterProvision_Request message to the NEF 116. The provisioning request message may include an indication associated with the AF 102 authorization ID, the UE ID, and a provisioning parameter, e.g., an indication of UE's preferred operating profile. The time may be associated with a validity duration or a scheduling time. For example, the time indication may determine when the requested operation profile may be applied.

At 350, the NEF 116 may determine whether the AF 102 has the authorization to invoke the requested services. The NEF 116 may retrieve AF 102 authorization information from the UDM 314. For example, the NEF 116 may retrieve the provisioned operating profile from the UDM 314.

At 355, the NEF 116 may send a parameter provisioning confirmation message to the AF 102. For example, the NEF 116 may send the Nnef-ParameterProvision_Confirm message to the AF 102.

At 360, the NEF 116 may invoke an access and mobility management function (AMF) service for parameter provisioning. The NEF 116 may invoke the AMF service for provisioning by sending a provisioning request message to the AMF 312. The AMF 312 may be a function of the CN. For example, the NEF 116 may send the Namf_UEParameterProvision_Request message to the AMF 312. The NEF 116 may send the provision request message to the AMF with which the UE 104 is registered. The provision request message may include UE ID, an indication of the UE's preferred operating profile, and a validity time.

At 365, the AMF 312 may invoke a RAN management function (RMF) 318 service to update a UE context to provision the updated UE context parameters. The RAN management function may be associated with the UE 104 and the BS 108 in FIG. 1. The AF 312 may send an update request message to the RMF 318 to update the UE context with the provided UE context parameter. The UE context parameter may include an indication of UE's preferred operating profile. For example, the AMF 312 may send an Nran_UEContext_UpdateReq to the BS 108.

At 370, the RMF 318 may update the UE 104 configuration according to the updated UE context parameter. For example, the RMF 318 may update the UE 104 by instructing a BS, e.g., the BS 108 in FIG. 1, to send a radio resource control (RRC) reconfiguration message to update the UE's RRC configuration according to the operating profile indicated by the updated UE context.

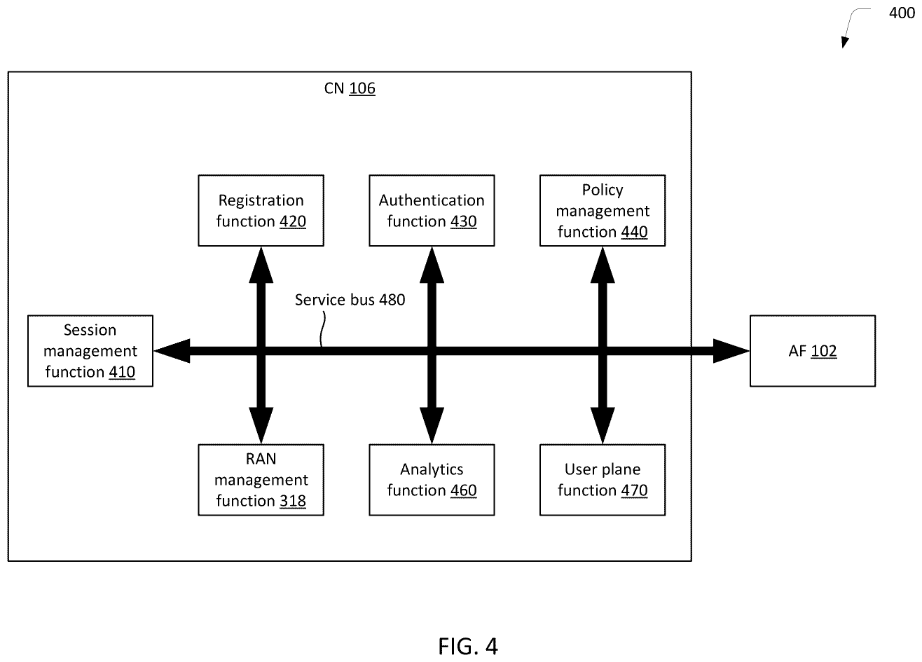

FIG. 4 illustrates a network environment 400 in accordance with some embodiments. The network is an example of NFs of CN 106 available on service bus 480. Service bus 480 may be used to facilitate communication between the connected NFs and the AF 102.

In some instances, a session management function (SMF) 410 may be connected to the service bus 480. The SMF 410 may be responsible for session establishment, modification, or release.

In some instances, a registration function 420 may be connected to the service bus 480. The registration function 420 may be responsible for managing the registration of UEs or AFs, e.g., AF 102.

In some instances, an authentication function (AUSF) 430 may be connected to the service bus 480. The AUSF 430 may support authentication for access of trusted or untrusted entities to the network, e.g., network 105 in FIG. 1.

In some instances, a policy management function (PCF) 440 may be connected to the service bus 480. The PCF 440 may control the parameters regulating the user data traffic.

In some instances, the RMF 318 may be connected to the service bus 480. The RAN management function may control and configure the operation of the RAN, including the BS 108 and the UE 104 in FIG. 1.

In some instances, an analytics function 460, e.g., NWDAF, may be connected to the service bus 480. The analytics function 460 may provide analytics to the core network NFs and to operations and maintenance (O&M).

In some instances, a user plane function (UPF) 470 may be connected to the service bus 480. The UPF 470 may be responsible for handling the user plane data traffic.

The AF 102 may directly invoke the NFs connected to the service bus 480. For example, the AF 102 may directly invoke RAN services for updated UE selected configuration by sending a parameter provisioning request directly to RMF 318. The direct access to NFs on the service bus 480 reduces the latency and overhead for the AF 102 requests compared with requests that are processed through the NEF.

The NEF may provide the authorization and user consent checking required before the AF 102 is allowed to invoke the NF services directly on the service bus 480. Once authorized, the AF 102 may be allowed to interact directly with the NFs, e.g., the RMF 318. A validation timer may regulate the direct access. For example, the AF 102 may be allowed to interact directly with the NFs on the service bus 480 for a predetermined timer. Other events, such as UE mobility, cell reselection, or other network conditions, may impact the AF 102 direct access to the NFs.

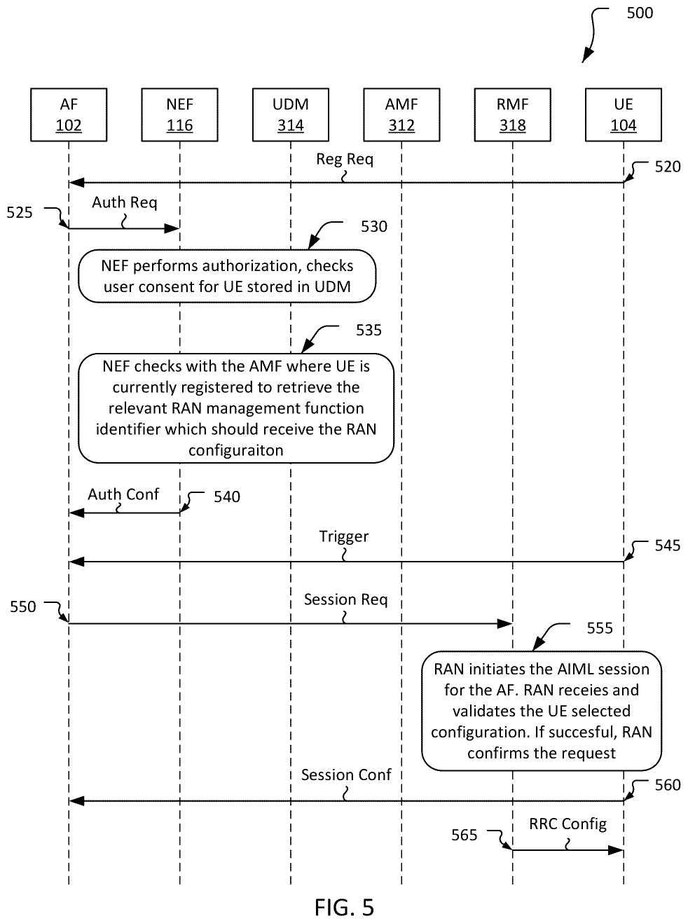

FIG. 5 illustrates a signaling diagram 500 in accordance with some embodiments. Signaling diagram 500 is an example of a provisioning procedure for setting a UE-selected RAN configuration through a direct interface to RMF 318.

The UE 104 may select a RAN configuration. The RAN configuration may include PHY or RRC configuration. The UE 104 may select the RAN configuration based on the AIML operation, e.g., based on the AIML requirements and capabilities and UE's knowledge about current and future requirements.

The UE 104 may provide the AIML processed results or a selected preferred RAN configuration to the AIML AF 102. UE may provide authorized metadata or enrichment information to RMF 318 to enable RMF 318 to perform the RAN configuration selection.

The AF 102 may invoke the NEF API to discover the RAN node to which the UE is connected or registered. The NEF may also authorize the AF 102 and check user consent for the influence of UE behavior.

The authorized AF 102 may initiate the establishment of an AIML session with RMF 318. The AF 102 may directly send the metadata or an indication of the selected RAN configuration to the RMF 318.

At 520, the UE 104 may send a registration request to the AF 102. For example, the AIML client in the UE may register with the AF to trigger authorization or onboarding with the MNO NEF 116. The UE may use application layer signaling to send UE registration request. The registration request or another message may include a list of provisioning parameters and consent inputs.

At 525, the AF 102 may check whether an authorization exists. If no authorization is associated with the NEF 116, the AF 102 may send an authorization request message to the NEF 116. For example, the AF 102 may use a Nnef_AFAuthorization_Request message to request authorization from the NEF 116. The authorization request message may include a UE identifier (ID), an indication of the type of update AIML session with RMF 318, a list of allowed UE provisioning parameters for which the AF 102 has received the user's consent, a user consent inputs, and a request for RAN controller identifier. The RAN controller identifier may be an address for direct invocation of the service-based interface from the RAN node. In general, when the direct connection is directed to an NF, the controller identifier may be the address, e.g., the IP address or the URI, of the NF associated with the UE.

At 530, NEF 116 may perform authorization in response to the authorization request message from AF 102. The NEF 116 may use the consent input and information associated with the consent retrieved from unified data management (UDM) 314 to authorize the AF 102. UDM may be a network node or NF that manages network users' data. For example, the NEF 116 may retrieve the UE consent information stored in the UDM.

At 535, the NEF 116 may send a request to the AMF 312, to which the UE 104 is currently registered, to retrieve the relevant RMF identifier, which should receive RAN configuration. The RMF identifier may be the Internet protocol (IP) address or the uniform resource identifier (URI) associated with the RMF or RAN node. In general, when the direct connection is directed to an NF, the controller identifier may be the address, e.g., IP address or URI, of the NF associated with the UE.

At 540, the NEF 116 may send an authorization confirmation message to the AF 102. For example, the NEF 116 may use the Nnef_AFAuthorization_Confirm message to inform the AF 102 whether the AF 102 is authorized to access NEF 116 or other NFs, e.g., RMF 318. The authorization confirmation message may include an indication that the AF 102 is authorized to access the NEF 116 or other NFs. The authorization confirmation message may include an authorization ID. When accessing the NEF 116 or other NFs, e.g., RMF 318, the AF 102 may use the authorization ID to indicate that it has authorization. The authorization confirmation may include a validity time that may indicate the duration for which the authorization is valid. The AF 102 may configure a timer based on the validity time. The authorization confirmation may include an RMF address. The RMF address may indicate the RMF that should receive the RAN configuration. The RMF address may be the IP address or the URI of the RMF or corresponding RAN node.

At 545, based on AIML inference, the AIML client in the UE 104 may trigger the AF 102 to initiate or modify the AIML session. The UE 104 may use application layer signaling to send the trigger to the AF 102. The trigger may include an AF 102 authorization ID, a UE ID, or an indication of the UE's selected RAN configuration.

At 550, the AF 102 may invoke a RAN service for UE configuration provisioning at the RMF 318. The AF 102 may invoke parameter provisioning services at RMF 318 by sending an AIML session request to RMF 318. For example, the AF 102 may send a Nran_AIMLSession_Create/NModify_Request message to the RMF 318. The session request message may include an indication associated with the AF 102 authorization ID, the UE ID, and an indication of the UE configuration provisioning, e.g., an indication of UE's selected RAN configuration.

At 555, the RMF 318 may receive the UE-selected RAN configuration and validate the request. For example, the RMF 318 may use the AF authorization ID received in the session request message to validate the UE-selected RAN configuration. The RMF 318 may retrieve information regarding UE's registered RAN configurations from the UDM 314.

At 560, based on a successful validation at 555, the RMF 318 may send a confirmation message to the AF 102. For example, the RMF 318 may send a Nran_AIMLSession_Create_Confirm message to the AF 102. The confirmation message may include a session ID.

At 565, the RMF 318 may update the UE 104 configuration according to the received selected RAN configuration. For example, the RMF 318 may update the UE 104 by instructing a BS, e.g., the BS 108 in FIG. 1, to send a radio resource control (RRC) reconfiguration message to update the UE's RRC configuration according to the selected RAN configuration indicated by the session request message.

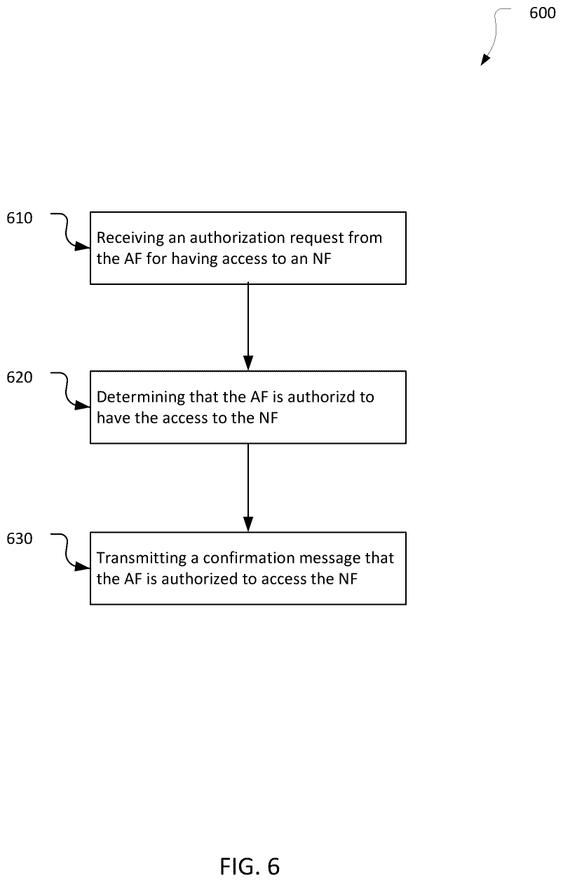

FIG. 6 illustrates an operational flow/algorithmic structure 600 in accordance with some embodiments. Operational flow/algorithmic structure 600 is an example of the NEF that authorizes an AF to access NFs. The operational flow/algorithmic structure 600 may be implemented by a network node, for example, the CN 106 or the network node 1000, or components therein, e.g., processors 1004.

The operational flow/algorithmic structure 600 may include, at 610, receiving an authorization request from the AF. The authorization request may be associated with access to an NF. The access to the NF may be indirect access through an NEF or a direct access.

The request may be a request to access an NF on the service bus. For example, the request may be a request to access an RMF.

The operational flow/algorithmic structure 600 may include, at 620, determining whether the AF is authorized to have access to the NF. The NEF may request and receive a message from the UDM that includes an indication of a consent associated with the UE. The NEF may request and receive a message from the AMF, including an indication of an identifier of the network function associated with the UE. The NEF may determine whether the AF is authorized to have access to the NF based on the indication of the consent received from the UDM or the indication of the identifier of the network received from the AMF.

The operational flow/algorithmic structure 600 may include, at 630, transmitting a confirmation message to the AF indicating that the AF is authorized to access the NF. The confirmation message may include a validity timer that may indicate how long the AF authorization is valid.

The NEF may also perform a parameter provisioning procedure. The NEF may receive a provisioning request from the AF. The NEF may determine that the AF is authorized to invoke the parameter provisioning service at the NEF. If the AF is successfully authorized, the NEF may send a confirmation message to the AF.

The NEF and AF may establish an AIML session. The AIML session may provide exposure to partial inferred results from NFs to the AF. In some instances, the NWDA NF may provide partial results to AF. The AIML session may provide AF with the provisioning of configuration parameters. In direct access, the AF may establish an AIML session with the NF.

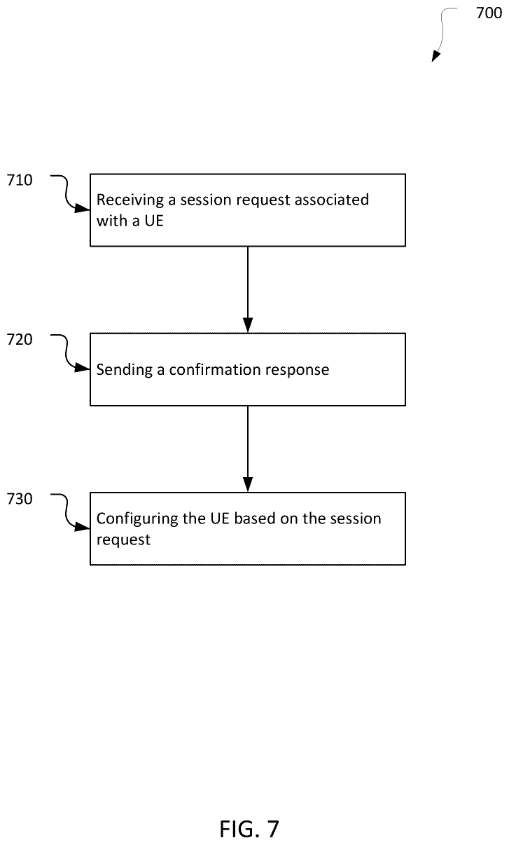

FIG. 7 illustrates an operational flow/algorithmic structure 700 in accordance with some embodiments. Operational flow/algorithmic structure 700 is an example of the RMF to establish direct access to an AF. The operational flow/algorithmic structure 700 may be implemented by a network node, for example, the CN 106, the BS 108, or the network node 1000, or components therein, e.g., processors 1004.

The operation flow/algorithmic structure 700 may include, at 710, receiving a session request from an AF where the request is associated with a UE. The session request may include a UE ID and an authorization ID associated with an AF. The session request may include a configuration associated with the UE.

The operation flow/algorithmic structure 700 may include, at 720, sending a confirmation response to the AF. The confirmation response may include a session ID.

The operation flow/algorithmic structure 700 may include, at 730, configuring the UE based on the session request. For example, the RMF may instruct the BS to send an RRC reconfiguration message to the UE based on the UE configuration in the session request message.

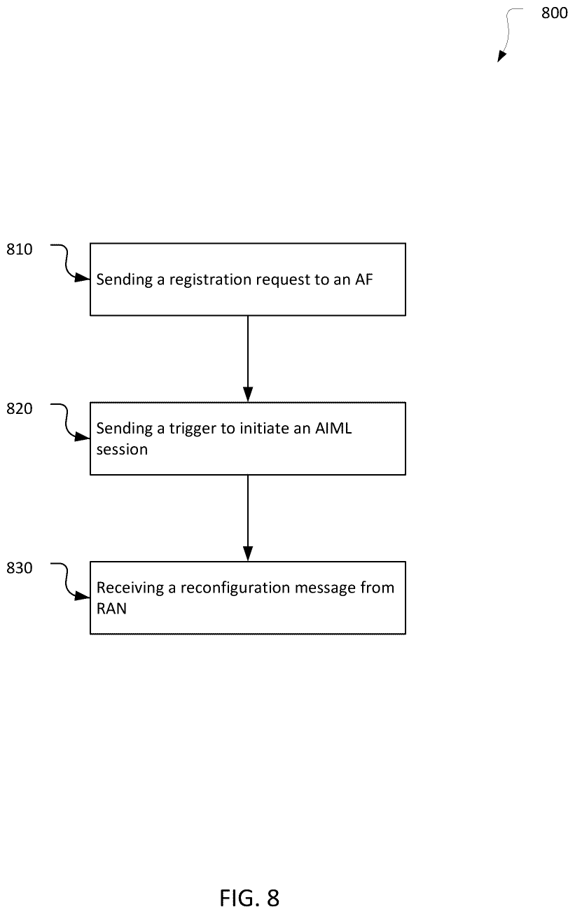

FIG. 8 illustrates an operational flow/algorithmic structure 800 in accordance with some embodiments. Operational flow/algorithmic structure 800 is an example of a UE to establish direct access to an RMF. The operation flow/algorithmic structure 800 may be implemented by a UE (for example, UE 104 or UE 900) or components therein, for example, processing circuitry 904.

The operation flow/algorithmic structure 800 may include, at 810, sending a registration request to an AF. The registration request may include one or more indications associated with UE consent.

The operation flow/algorithmic structure 800 may include, at 820, sending a trigger to initiate an AIML session. The trigger may include an indication of a UE-selected configuration. The UE selected configuration may include a mobility management policy, a duty cycle, a carrier aggregation configuration, a measurement configuration, a radio resource management (RRM) configuration, a RAN mobility configuration, an AIML model selection indication, a resource allocation indication, or a beamforming selection indication.

The operation flow/algorithmic structure 800 may include, at 830, receiving a reconfiguration message from RAN. The reconfiguration message may be based on the UE-selected configuration. In one example, the reconfiguration message may be an RRC reconfiguration message.

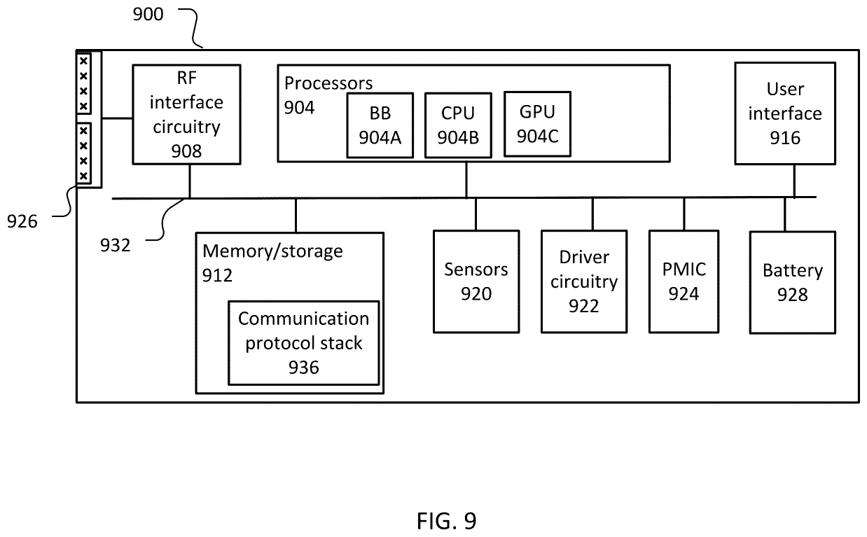

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

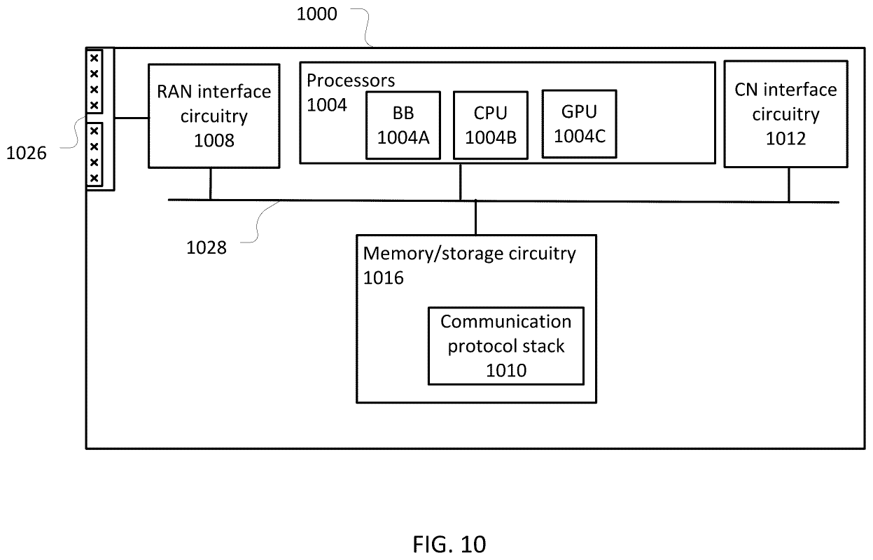

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to the like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices generally recognized as meeting or exceeding industry or governmental requirements for maintaining users' privacy. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method to be implemented by a network exposure function (NEF) of a cellular network, the method including: receiving, from an application function (AF), an authorization request to have an access to a network function (NF) of the cellular network; determining, by the NEF, that the AF is authorized to have the access to the NF of the cellular network; and transmitting, to the AF, a confirmation message including an indication that the AF is authorized to have the access to the NF of the cellular network.

Example 2 includes the method of example 1 or other examples herein, wherein the network function is a radio access network (RAN) management function.

Example 3 includes the method of examples 1 or 2 or other examples herein, wherein the confirmation message includes an authorization identifier and a validity timer.

Example 4 includes the method of any of examples 1-3 or other examples herein, wherein the authorization request to have the access to the NF of the cellular network includes a UE identification and a UE consent input.

Example 5 includes the method of any of examples 1˜4 or other examples herein, wherein the access is a direct access.

Example 6 includes the method of any of examples 1-5 or other examples herein, wherein the authorization request for the direct access to the NF of the cellular network includes a controller identifier.

Example 7 includes the method of any of examples 1-6 or other examples herein, wherein the confirmation message includes an NF address.

Example 8 includes the method of any of examples 1-7 or other examples herein, wherein the NF address is an Internet protocol (IP) address or a uniform resource identifier (URI) associated with the NF of the cellular network.

Example 9 includes the method of any of examples 1-8 or other examples herein, wherein said determining that the AF is authorized to have the access to the network function of the cellular network includes: receiving a first message from a unified data management (UDM) including an indication of a consent associated with a user equipment (UE); receiving a second message from an access and mobility management function (AMF) including an indication of an identifier of the network function associated with the UE; and determining the indication based on the indication of the consent associated with the UE or the indication of the identifier of the network function associated with the UE.

Example 10 includes the method of any of examples 1-9 or other examples herein, further including: receiving, from the AF, an NEF provisioning request to invoke a parameter provisioning service of the NEF; determining that the AF is authorized to invoke the parameter provisioning service; and sending, to the AF, a provisioning confirmation message.

Example 11 includes the method of any of examples 1-10 or other examples herein, wherein the NEF provisioning request includes an authorization identifier associated with the AF, a UE identifier, a UE operating profile, and a validity time.

Example 12 includes the method of any of examples 1-11 or other examples herein, further including: sending, to an access and mobility management function (AMF), an AMF provisioning request to invoke a parameter provisioning service of the AMF.

Example 13 includes the method of any of examples 1-12 or other examples herein, wherein the NF is a first NF, and the method further includes: sending, to AF, partial inferred results associated with a second NF.

Example 14 includes the method of any of examples 1-13 or other examples herein, wherein the second NF is a network data analytics (NWDA) NF.

Example 15 includes a method to be implemented by a radio access network (RAN) management function of a cellular network, the method including: receiving, from an application function (AF), a session request associated with a user equipment (UE); sending, to the AF, a confirmation response associated with the session request; and configuring the UE based on the session request.

Example 16 includes the method of example 15 or other examples herein, wherein the session request includes a UE identifier, a UE selected configuration, and an authorization identifier associated with the AF.

Example 17 includes the method of examples 15 or 16 or other examples herein, wherein said configuring the UE base on the session request includes: sending, to the UE, a radio resource control (RRC) reconfiguration message.

Example 18 includes a method to be implemented by a user equipment (UE), the method including: sending, to an application function (AF), a registration request; sending, to the AF, a trigger to initiate or modify an AIML session based on an AIML inference; and receiving a reconfiguration message from a radio access network (RAN) based on the trigger.

Example 19 includes the method of example 18 or other examples herein, wherein the reconfiguration message is a radio resource control (RRC) reconfiguration message.

Example 20 includes the method of examples 18 or 19 or other examples herein, wherein the registration request includes a UE consent indication.

Example 21 includes the method of any of examples 18-20 or other examples herein, further including: sending, to the AF, a UE selected RAN configuration.

Example 22 includes the method of any of examples 18-21 or other examples herein, wherein the trigger includes an indication of the UE selected RAN configuration.

Example 23 includes the method of any of examples 18-22 or other examples herein, wherein the UE selected RAN configuration includes a physical layer (PHY) configuration or a radio resource control (RRC) configuration.

Example 24 includes the method of any of examples 18-23 or other examples herein, wherein the UE selected RAN configuration includes a mobility management policy, a duty cycle, a carrier aggregation configuration, a measurement configuration, a radio resource management (RRM) configuration, a RAN mobility configuration, an AIML model selection indication, a resource allocation indication, or a beamforming selection indication.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example includes a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing an authorization request, received from an application function (AF), to have an access to a network function (NF) of a cellular network;
determining that the AF is authorized to have the access to the NF of the cellular network; and
generating a confirmation message for transmitting to AF, wherein the confirmation message includes authorization information indicating that the AF is authorized to have the access to the NF of the cellular network.

2. The method of claim 1, wherein the NF is a radio access network (RAN) management function.

3. The method of claim 1, wherein the confirmation message includes an authorization identifier and a validity timer.

4. The method of claim 1, wherein the authorization request to have the access to the NF of the cellular network includes a user equipment (UE) identification and a UE consent input.

5. The method of claim 1, wherein:
the access is a direct access;
the authorization request for the direct access to the NF of the cellular network includes a controller identifier; and
the confirmation message includes an NF address.

6. The method of claim 5, wherein the NF address is an Internet protocol (IP) address or a uniform resource identifier (URI) associated with the NF of the cellular network.

7. The method of claim 5, wherein said determining that the AF is authorized to have the access to the network function of the cellular network comprises:
processing a first message received from a unified data management (UDM) including an indication of a consent associated with a user equipment (UE);
processing a second message received from an access and mobility management function (AMF) including an indication of an identifier of the network function associated with the UE; and
determining the authorization information based on the indication of the consent associated with the UE or the indication of the identifier of the network function associated with the UE.

8. The method of claim 1, further comprising:
processing an NEF provisioning request received from the AF to invoke a parameter provisioning service;
determining that the AF is authorized to invoke the parameter provisioning service; and
generating, for transmitting to the AF, a provisioning confirmation message.

9. The method of claim 8, wherein the NEF provisioning request includes an authorization identifier associated with the AF, a UE identifier, a UE operating profile, and a validity time.

10. The method of claim 8, further comprising:
generating, for transmitting to an access and mobility management function (AMF), an AMF provisioning request to invoke a parameter provisioning service of the AMF.

11. The method of claim 1, wherein the NF is a first NF, and the method further comprises:
generating, for transmitting to AF, partial inferred results associated with a second NF.

12. The method of claim 11, wherein the second NF is a network data analytics (NWDA) NF.

13. An apparatus comprising:
processing circuitry to:
process a session request associated with a user equipment (UE), the session request received from an application function (AF);
generate, for transmitting to the AF, a confirmation response associated with the session request; and
configure the UE based on the session request; and
interface circuitry coupled with the processing circuitry, the interface circuitry to communicatively couple the processing circuitry with a component.

14. The apparatus of claim 13, wherein the session request includes a UE identifier, a UE selected configuration, and an authorization identifier associated with the AF.

15. The apparatus of claim 13, wherein to configure the UE based on the session request, the processing circuitry is to:
generate, for transmitting to the UE, a radio resource control (RRC) reconfiguration message.

16. One or more non-transitory, computer-readable media having instructions that are to be executed to cause a processing circuitry to:
generate, for transmitting to an application function (AF), a registration request;
generate, for transmitting to the AF, a trigger to initiate or modify an artificial intelligent machine learning (AIML) session based on an AIML inference; and
processing a reconfiguration message based on the trigger, the reconfiguration message received from a radio access network (RAN).

17. The one or more non-transitory, computer-readable media of claim 16, wherein the reconfiguration message is a radio resource control (RRC) reconfiguration message, and the registration request includes a UE consent indication.

18. The one or more non-transitory, computer-readable media of claim 16, wherein the instructions are to be executed to further cause the processing circuitry to:
generate for transmitting to the AF, a UE selected RAN configuration.

19. The one or more non-transitory, computer-readable media of claim 18, wherein:
the trigger includes an indication of the UE selected RAN configuration; and
the UE selected RAN configuration includes a physical layer (PHY) configuration or a radio resource control (RRC) configuration.

20. The one or more non-transitory, computer-readable media of claim 18, wherein the UE selected RAN configuration includes a mobility management policy, a duty cycle, a carrier aggregation configuration, a measurement configuration, a radio resource management (RRM) configuration, a RAN mobility configuration, an AIML model selection indication, a resource allocation indication, or a beamforming selection indication.
